(19) United States
(12) Patent Application Publication
(10) Pub. No.: US 2019/0204876 A1
(43) Pub. Date: Jul. 4, 2019

(54) FLEXIBLE FOLDABLE DISPLAY SCREEN AND PREPARATION METHOD THEREOF

(71) Applicants: Kunshan New Flat Panel Display Technology Center Co., Ltd., Kunshan (CN); KunShan Go-Visionox Opto-Electronics Co., Ltd., Kunshan (CN)

(72) Inventors: Liwei DING, Kunshan (CN); Xiuqi HUANG, Kunshan (CN); Hui ZHU, Kunshan (CN); Xiaobao ZHANG, Kunshan (CN)

(21) Appl. No.: 16/317,476

(22) Filed: Jan. 11, 2019

Related U.S. Application Data
(63) Continuation of application No. PCT/CN2017/102279, filed on Sep. 19, 2017.

(30) Foreign Application Priority Data
Sep. 29, 2016 (CN) 201610864036.3

(51) Int. Cl. G06F 1/16; G09F 9/30; G06F 3/041

(52) U.S. Cl. CPC G06F 1/1652; G06F 3/0412; G09F 9/301

(57) ABSTRACT

The present disclosure provides a flexible foldable display screen and a manufacturing method thereof. The method includes: forming a flexible screen body on a glass substrate, wherein the flexible screen body includes a display area and a curing assembling area formed at an end of the flexible screen body; disposing a controlling IC in the curing assembling area; and peeling off a part of the glass substrate corresponding to the display area.

### CROSS-REFERENCE TO RELATED APPLICATIONS

This application is a continuation of international application No. PCT/CN2017/102279 filed on Sep. 19, 2017, which claims priority of Chinese Patent Application No. 201610864036.3, entitled “flexible foldable display screen and manufacturing method thereof” filed on Sep. 29, 2016. Both applications are incorporated herein in their entirety by reference.

### TECHNICAL FIELD

The present disclosure relates to a structure and a manufacturing method of a display screen, and more particularly, to a structure and a manufacturing method of a flexible foldable display screen.

### BACKGROUND

Flexible display screens have the advantage of significant flexibility deformation, and may be bent and folded at a large angle, and thus the portability of devices may be effectively improved by using this type of screen. With the maturity of flexible display technologies, the flexible display screens have gradually integrated into mobile devices such as mobile phones and tablets, and become main tools of our lives.

The existed (rigid or semi-rigid) display screens generally include a glass substrate (layer), a flexible screen body (layer) and a controlling IC (layer) combined sequentially. The flexible screen body for displaying images includes pixel units densely arranged on a flexible substrate and signal lines (harnesses) disposed at the periphery of the pixel units and traced at the edge of the flexible screen body. The controlling IC for generating control signals or power signals uses a flexible circuit board (FPC) carrying chip components and a cured packaged integrated circuit module. The glass substrate for supporting and curing the flexible screen body uses an elastic and rigid glass substrate. The existed display screens also include a power circuit, which includes a semi-cured core and a larger size power component.

How to separate the flexible screen body from the whole screen individually, how to fully utilize characteristics of the flexible screen body to form good display effect, how to reflect display quality of the flexible screen body, and how to eliminate negative influence of control lines while ensuring the display effect and quality need to be redesigned or technically improved.

### SUMMARY

In view of the above, embodiments of the present disclosure provide a method for manufacturing a flexible foldable display screen, which solves technical problems that display effect becomes worse due to the screen circuit and the driving chip are damaged during bending or peeling process of the flexible screen body.

The embodiments of the present disclosure further provide a flexible foldable display screen, which solves a technical problem that existed mobile devices cannot fully utilize the flexible screen body to improve the display effect.

A method for manufacturing a flexible foldable display screen of the present disclosure, including: forming a flexible screen body on a glass substrate, wherein the flexible screen body includes a display area and a curing assembling area formed at an end of the flexible screen body; disposing a controlling IC in the curing assembling area; and peeling off a part of the glass substrate corresponding to the display area.

In an embodiment of the present disclosure, the end of the flexible screen body is an edge of the flexible screen body extending along an extension direction of the flexible screen body, or a pair of opposite edges of the flexible screen body extending along the extension direction of the flexible screen body, or a part of the edge of the flexible screen body, or a part of the opposite edges of the flexible screen body.

In an embodiment of the present disclosure, the method further includes: forming a pixel sparse area at an edge of the display area, wherein a pixel unit density of pixel units disposed in the pixel sparse area is smaller than that of pixel units disposed outside the pixel sparse area, and a pitch between adjacent pixel units in the pixel sparse area accommodates to an outer diameter of a signal line.

In an embodiment of the present disclosure, the method further includes: forming a pixel sparse area at an edge of the display area, wherein adjacent pixel units in the pixel sparse area form a pixel matrix, the pixel matrix is evenly arranged, and a pitch between adjacent pixel matrices in the pixel sparse area accommodates to an outer diameter of a signal line.

In an embodiment of the present disclosure, the method further includes: forming a pixel sparse area at an edge of the display area, wherein a pixel unit density is gradually decreased from an inner side to an outer side in the pixel sparse area, and a pitch between adjacent pixel units gradually becomes larger and accommodates to an outer diameter of a signal line.

In an embodiment of the present disclosure, the peeling off a part of the glass substrate corresponding to the display area is performed by a laser lift-off technique.

In an embodiment of the present disclosure, the method further includes: forming a touch input region on a part of the glass substrate corresponding to the curing assembling area.

A flexible foldable display screen of the present disclosure, including a flexible screen body, a glass substrate and a controlling IC, wherein a curing assembling area is defined at an end of the flexible screen body, a flexible screen body outside the curing assembling area is used as a display area, the controlling IC is disposed at a top of the curing assembling area, and the glass substrate is disposed at a bottom of the curing assembling area.

In an embodiment of the present disclosure, a pixel sparse area is formed at an edge of the display area, a pixel unit density of pixel units disposed in the pixel sparse area is smaller than that of pixel units outside the pixel sparse area, and a pitch between adjacent pixel units in the pixel sparse area accommodates to an outer diameter of a signal line.

In an embodiment of the present disclosure, adjacent pixel units in the pixel sparse area form a pixel matrix, the pixel matrix is evenly arranged, and a pitch between adjacent pixel matrices in the pixel sparse area accommodates to an outer diameter of a signal line.

In an embodiment of the present disclosure, a pixel unit density is gradually decreased from an inner side to an outer side in the pixel sparse area, and a pitch between adjacent pixel units gradually becomes larger and accommodates to an outer diameter of a signal line.

In an embodiment of the present disclosure, a pixel sparse area is formed at an edge of the display area, a pixel unit density is gradually decreased from an inner side to an outer side in the pixel sparse area, and a pitch between adjacent pixel units gradually becomes larger accommodates to an outer diameter of a signal line.

In an embodiment of the present disclosure, in the pixel sparse area, a plurality of adjacent pixel units form a pixel matrix, the pixel matrix is evenly arranged, and a pitch between adjacent pixel matrices accommodates to an outer diameter of a signal line.

In an embodiment of the present disclosure, the end of the flexible screen body is an edge of the flexible screen body extending along an extension direction of the flexible screen body, or a pair of opposite edges of the flexible screen body extending along the extension direction of the flexible screen body, or a part of the edge of the flexible screen body, or a part of the opposite edges of the flexible screen body.

According to the method for manufacturing a flexible foldable display screen of the present disclosure, characteristics of the present flexible screen bodies may be fully utilized and existed display screen products may be fully utilized, to form a flexible display screen that meets the requirement of the market. By concentrating the components which are not easily bent or folded on the curing assembling area of the flexible screen body that does not need to be peeled off, technical problems that display effect becomes worse due to the screen circuit and the driving chip are damaged during bending or peeling process of the flexible screen body are solved.

The flexible foldable display screen of the present disclosure has reliable quality and fully utilizes a flexible platform; a screen formed by the display area may display without borders, and meanwhile, reliable transmission of control signals and power signals may be ensured.

### BRIEF DESCRIPTION OF THE DRAWINGS

FIG. 1 is a front cross-sectional view of a flexible foldable display screen according to an embodiment of the present disclosure.

FIG. 2 is a structure diagram (a plan view) of a pixel unit arrangement of a flexible screen body of a display area in a flexible foldable display screen according to an embodiment of the present disclosure.

FIG. 3 is a structure diagram (a plan view) of a pixel unit arrangement of a flexible screen body of a display area in a flexible foldable display screen according to another embodiment of the present disclosure.

FIG. 4 is a structure diagram (a plan view) of a pixel unit arrangement of a flexible screen body of a display area in a flexible foldable display screen according to another embodiment of the present disclosure.

FIG. 5 is a flowchart of a method for manufacturing a flexible foldable display screen of the present disclosure.

### DETAILED DESCRIPTION

Technical solutions in the embodiments of the present disclosure will be described clearly and completely with reference to the accompanying drawings in the present disclosure. Apparently, the embodiments described herein are merely some but not all the embodiments of the present disclosure. Based on embodiments of the present disclosure, all other embodiments obtained by those skilled in the art without paying creative effort belong to the protection scope of the present disclosure.

A method for manufacturing a flexible foldable display screen of the embodiment includes: forming a curing assembling area at an end of a flexible screen body; disposing a controlling IC in the curing assembling area; making a part of the flexible screen body outside the curing assembling area as a display area, peeling off a part of the glass substrate combined with the display area; and adjusting a size of the glass substrate to accommodate the glass substrate with the curing assembling area.

Specifically, a flexible screen body is formed on the glass substrate. The flexible screen body includes a display area and a curing assembling area at an end of the flexible screen body. A controlling IC is disposed in the curing assembling area. A part of the glass substrate combined with the display area is peeled off. It should be noted that the controlling IC could be disposed in the curing assembling area or could be disposed at an upper surface in the curing assembling area, and the present disclosure is not limited thereto.

According to the method for manufacturing a flexible foldable display screen of the embodiment, characteristics of the present flexible screen bodies may be fully utilized and existed display screen products may be fully utilized, to form a flexible display screen that meets the requirement of the market. By concentrating the components which are not easily bent or folded on the curing assembling area of the flexible screen body that does not need to be peeled off, a peeling yield of the flexible screen body peeling from the glass substrate and the controlling IC could be ensured, and the screen circuit and the driving chip would not be damaged.

The end of the above-mentioned flexible screen body may be an edge of the flexible screen body extending along an extension direction of the flexible screen body, or a pair of opposite (two) edges of the flexible screen body extending along the extension direction of the flexible screen body, or a part of the edge of the flexible screen body, or a part of the opposite edges of the flexible screen body, or an interval portion of the edge of the flexible screen body, or an interval portion of the opposite edges of the flexible screen body.

The above-mentioned interval portion refers to two or more portions spaced from each other.

In the method for manufacturing a flexible foldable display screen of the embodiment, a laser lift-off technique is used to peel off a part of the glass substrate combined with the display area.

In the method for manufacturing a flexible foldable display screen of the embodiment, by utilizing collimation characteristics and high energy adjustable characteristics of the laser, it is available to separate the layers from other layers of the display screen accurately and an separated surface is flat.

The method for manufacturing a flexible foldable display screen of the embodiment further includes: forming a touch input region on a part of the glass substrate corresponding to the curing assembling area.

The above-mentioned touch input region could be formed at any position of the glass substrate, for example, the touch input region could be formed between one side of the glass substrate adjacent to the flexible screen body and the display area, or at the other side of the glass substrate away from the flexible screen body, and the present disclosure is not limited thereto.

In the method for manufacturing a flexible foldable display screen of the embodiment, the glass substrate for supporting purpose could be fully utilized, to form a fixed interactive signal input structure or input circuit, and thus a fixed input interface could be obtained without adding extra space structures.

The above-mentioned forming the touch input region includes disposing corresponding circuits and connecting the circuits.

In addition, normally, a monochromatic strip formed by signal line harnesses traced at the edge of the display area further forms a monochrome border (for example, black) at the edge of the flexible screen body, which affects the overall display effect of the flexible screen body. To solve this problem, the method for manufacturing a flexible foldable display screen of the embodiment further includes: forming a pixel sparse area at an edge of the display area, wherein the pixel unit density of the pixel unit disposed in the pixel sparse area is smaller than that of the pixel unit disposed outside the pixel sparse area, a pitch between adjacent pixel units in the pixel sparse area accommodates to an outer diameter of signal lines; and the signal lines are evenly disposed between the pixel units in the pixel sparse area.

The above-mentioned pixel unit density refers to the number of pixel units disposed in a unit area.

In the method for manufacturing a flexible foldable display screen of the embodiment, by reducing the pixel unit density at the edge of the flexible screen body in the display area, small line trace space for the tracing of a signal line could be divided at the edge of the display area by utilizing the pixel unit. Since the line trace space is orderly distributed, signal lines in wiring harnesses may be distributed as evenly as possible; meanwhile, diffraction and brightness effects generated when the pixel unit emits light may effectively reduce the differential reflection of a single signal line. In this way, a monochrome strip at the edge of the display area is eliminated, and borderless effect is obtained, and thus the overall display effect of the flexible screen body is significantly improved.

The method for manufacturing a flexible foldable display screen of the embodiment further includes: in the pixel sparse area, a pixel matrix is formed by adjacent pixel units; the pixel matrix is evenly arranged; a pitch of adjacent pixel matrices in the pixel sparse area accommodates to an outer diameter of signal lines; and signal lines are evenly arranged between the pixel matrices.

The above-mentioned pixel matrix could be composed of adjacent pixel units to form a triangle, a rectangle, a diamond or other polygonal contour.

In the method for manufacturing a flexible foldable display screen of the embodiment, the pixel unit density may be adjusted locally in the pixel sparse area, to accommodate to the number of the signal lines and the distance of tracing.

The method for manufacturing a flexible foldable display screen of the embodiment further includes: in the pixel sparse area, a pixel unit density is gradually decreased from an inner side (a side toward the middle of the flexible screen body, vertical or non-vertical) to an outer side (a side toward the edge of the flexible screen body, vertical or non-vertical); in the pixel sparse area, the pitch of pixel units gradually becomes larger and accommodates to the outer diameter of the signal lines; and the signal lines are evenly disposed between the pixel units in the pixel sparse area.

The pixel unit density outside the pixel sparse area is larger than that in the inner side of the pixel sparse area, and the pixel unit density in the inner side of the pixel sparse area is larger than that in the outer side of the pixel sparse area.

In the method for manufacturing a flexible foldable display screen of the embodiment, a sparse tracing area and a dense tracing area could be formed in the sparse pixel area under the premise of ensuring the display effect, and thus a reasonable tracing of the signal harnesses is ensured. The dense tracing at the extreme edge has the lowest visual effect quality. However, the borders of the monochromatic strips are not formed may be still ensured, and thus a frameless effect is realized.

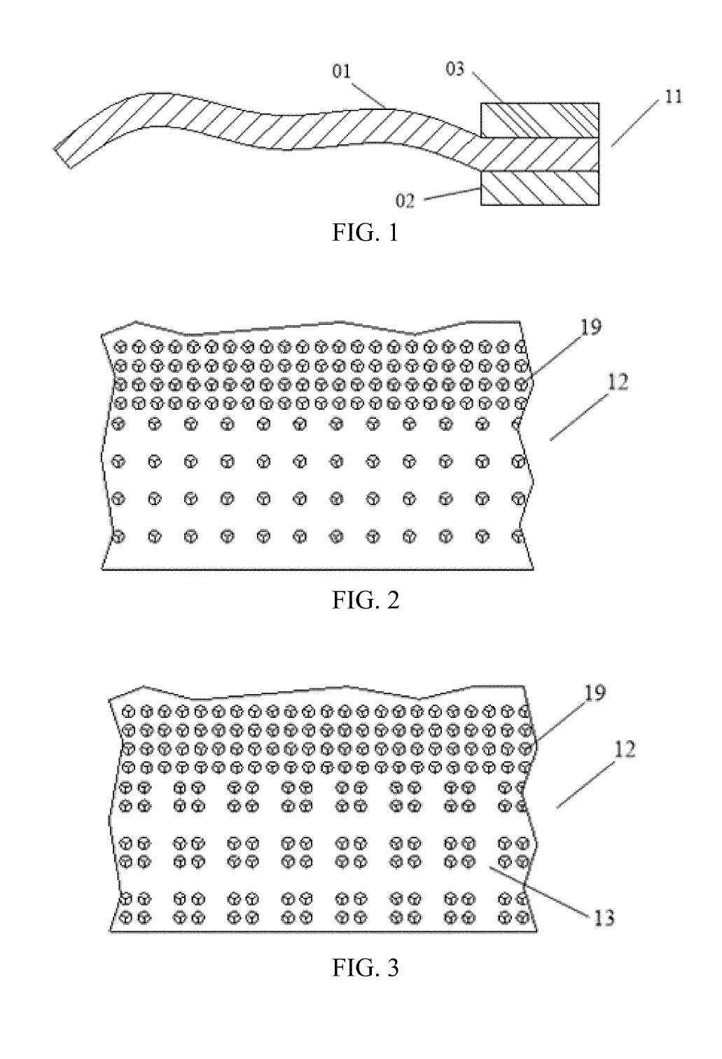

FIG. 1 is a front cross-sectional view of a flexible foldable display screen according to an embodiment. As shown in FIG. 1, the flexible foldable display screen of the embodiment includes a flexible screen body 01, a glass substrate 02 and a controlling IC 03. A curing assembling area 11 is defined at an end of the flexible screen body 01. A flexible screen body outside the curing assembling area 11 is used as a display area. The controlling IC 03 is disposed at the top of the curing assembling area 11, and the glass substrate 02 is disposed at the bottom of the curing assembling area 11.

FIG. 2 is a structure diagram (a plan view) of a pixel unit arrangement of a flexible screen body of a display area in a flexible foldable display screen according to an embodiment. As shown in FIG. 2, according to the flexible foldable display screen of the embodiment, a pixel sparse area 12 is formed at an edge of the flexible screen body 01, and a pixel unit density of a pixel unit 19 disposed in the pixel sparse area 12 is smaller than that of a pixel unit 19 disposed outside the pixel sparse area 12.

A pitch between pixel units 19 in the pixel sparse area 12 accommodates to an outer diameter of a signal line, which is equal to or slightly larger than the outer diameter of the signal line.

Signal lines are evenly disposed between pixel units 19 in the pixel sparse area 12.

FIG. 3 is a structure diagram (a plan view) of a pixel unit arrangement of a flexible screen body of a display area in a flexible foldable display screen according to another embodiment. As shown in FIG. 3, based on the structure of the previous embodiment, in the pixel sparse area 12, a pixel matrix 13 is formed by a plurality of adjacent pixel units 19, and the pixel matrix 13 is evenly arranged.

The pitch between adjacent pixel matrices in the pixel sparse area 12 accommodates to the outer diameter of a signal line.

The signal line is evenly arranged between pixel matrices 13 in the pixel sparse area 12.

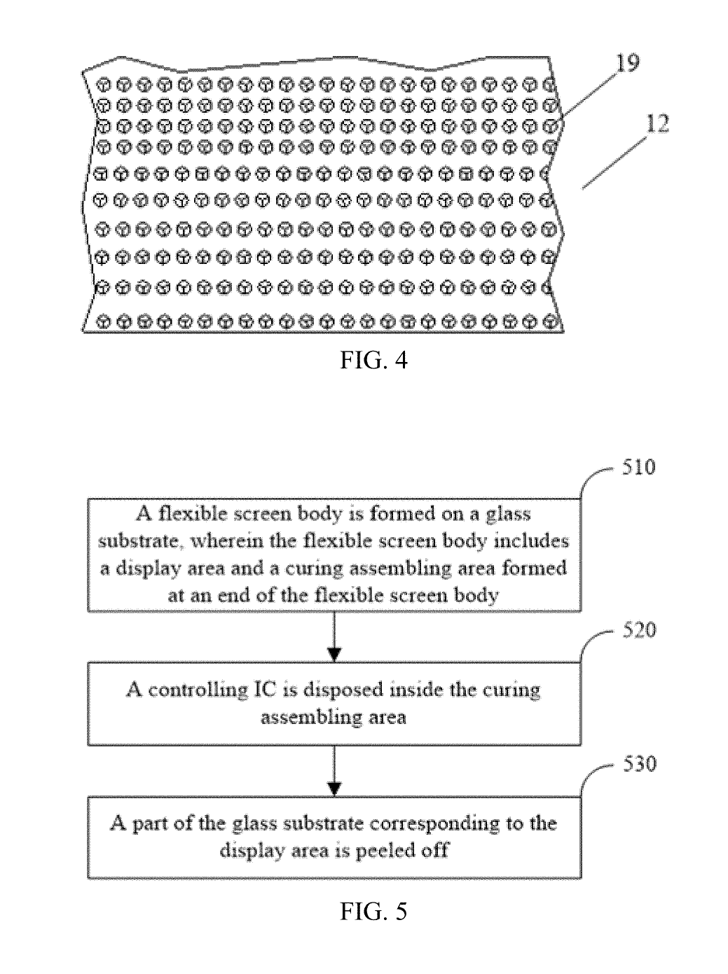

FIG. 4 is a structure diagram (a plan view) of a pixel unit arrangement of a flexible screen body of a display area in a flexible foldable display screen according to another embodiment. As shown in FIG. 4, based on the structure of the previous embodiment, the pixel unit density of the pixel unit 19 is gradually decreased from an inner side to an outer side in the pixel sparse area 12. The pitch between pixel units in the pixel sparse area 12 gradually becomes larger from an inner side to an outer side and accommodates to the outer diameter of the signal line.

The signal line is evenly arranged between pixel units in the pixel sparse area.

FIG. 5 is a flowchart of a method for manufacturing a flexible foldable display screen of the present disclosure. As shown in FIG. 5, the method includes following steps.

510: a flexible screen body is formed on a glass substrate, wherein the flexible screen body includes a display area and a curing assembling area formed at an end of the flexible screen body.

520: a controlling IC is disposed in the curing assembling area.

530: a part of the glass substrate corresponding to the display area is peeled off.

In the embodiment of the present disclosure, a size of the glass substrate is adjusted, for example, a part of the glass substrate corresponding to the display area is peeled off, and the residual glass substrate after the peeling process accommodates to the curing assembling area.

The above description is only preferred embodiments of the present disclosure and should not be intended to limit the present disclosure. Those skilled in the art can make various modifications and variations to the present disclosure. Any modification, equivalent substitution, improvement etc. made within the spirit and principle of the present disclosure should be encompassed in the protection scope of the present disclosure.

### INDUSTRIAL APPLICABILITY

In the method for manufacturing a flexible foldable display screen of the present disclosure, by concentrating the components which are not easily bent or folded on the curing assembling area of the flexible screen body that does not need to be peeled off, a peeling yield of the flexible screen body peeling from the glass substrate and the controlling IC could be ensured, and the screen circuit and the driving chip would not be damaged. The flexible foldable display screen of the present disclosure has reliable quality and fully utilizes a flexible platform; a screen formed by the display area may display without borders, and meanwhile, reliable transmission of control signals and power signals may be ensured.

What is claimed is:

1. A method for manufacturing a flexible foldable display screen, comprising:
forming a flexible screen body on a glass substrate, the flexible screen body comprising a display area and a curing assembling area formed at an end of the flexible screen body;
disposing a controlling IC in the curing assembling area; and
peeling off a part of the glass substrate corresponding to the display area.

2. The method for manufacturing a flexible foldable display screen of claim 1, wherein the end of the flexible screen body is an edge of the flexible screen body extending along an extension direction of the flexible screen body, or a pair of opposite edges of the flexible screen body extending along the extension direction of the flexible screen body, or a part of the edge of the flexible screen body, or a part of the opposite edges of the flexible screen body.

3. The method for manufacturing a flexible foldable display screen of claim 1, further comprising: forming a pixel sparse area at an edge of the display area, wherein a pixel unit density of pixel units disposed in the pixel sparse area is smaller than that of pixel units disposed outside the pixel sparse area, and a pitch between adjacent pixel units in the pixel sparse area accommodates to an outer diameter of a signal line.

4. The method for manufacturing a flexible foldable display screen of claim 1, further comprising: forming a pixel sparse area at an edge of the display area, wherein adjacent pixel units in the pixel sparse area form a pixel matrix, the pixel matrix is evenly arranged, and a pitch between adjacent pixel matrices in the pixel sparse area accommodates to an outer diameter of a signal line.

5. The method for manufacturing a flexible foldable display screen of claim 1, further comprising: forming a pixel sparse area at an edge of the display area, wherein a pixel unit density is gradually decreased from an inner side to an outer side in the pixel sparse area, and a pitch between adjacent pixel units gradually becomes larger and accommodates to an outer diameter of a signal line.

6. The method for manufacturing a flexible foldable display screen of claim 1, wherein the peeling off a part of the glass substrate corresponding to the display area is performed by a laser lift-off technique.

7. The method for manufacturing a flexible foldable display screen of claim 1, further comprising:
forming a touch input region on a part of the glass substrate corresponding to the curing assembling area.

8. A flexible foldable display screen, comprising a flexible screen body, a glass substrate and a controlling IC, wherein a curing assembling area is defined at an end of the flexible screen body, a flexible screen body outside the curing assembling area is used as a display area, the controlling IC is disposed at a top of the curing assembling area, and the glass substrate is disposed at a bottom of the curing assembling area.

9. The flexible foldable display screen of claim 8, wherein a pixel sparse area is formed at an edge of the display area, a pixel unit density of pixel units disposed in the pixel sparse area is smaller than that of pixel units outside the pixel sparse area, and a pitch between adjacent pixel units in the pixel sparse area accommodates to an outer diameter of a signal line.

10. The flexible foldable display screen of claim 9, wherein adjacent pixel units in the pixel sparse area form a pixel matrix, the pixel matrix is evenly arranged, and a pitch between adjacent pixel matrices in the pixel sparse area accommodates to an outer diameter of a signal line.

11. The flexible foldable display screen of claim 9, wherein a pixel unit density is gradually decreased from an inner side to an outer side in the pixel sparse area, and a pitch between adjacent pixel units gradually becomes larger and accommodates to an outer diameter of a signal line.

12. The flexible foldable display screen of claim 8, wherein a pixel sparse area is formed at an edge of the display area, a pixel unit density is gradually decreased from an inner side to an outer side in the pixel sparse area, and a pitch between adjacent pixel units gradually becomes larger and accommodates to an outer diameter of a signal line.

13. The flexible foldable display screen of claim 11, wherein in the pixel sparse area, a plurality of adjacent pixel units form a pixel matrix, the pixel matrix is evenly arranged, and a pitch between adjacent pixel matrices accommodates to an outer diameter of a signal line.

14. The flexible foldable display screen of claim 8, wherein the end of the flexible screen body is an edge of the flexible screen body extending along an extension direction of the flexible screen body, or a pair of opposite edges of the flexible screen body extending along the extension direction of the flexible screen body, or a part of the edge of the flexible screen body, or a part of the opposite edges of the flexible screen body.
